(19) United States
(12) Patent Application Publication
(10) Pub. No.: US 2010/0223667 A1
(43) Pub. Date: Sep. 2, 2010

(54) APPARATUS, SYSTEM, AND METHOD FOR START-UP AUTHENTICATION

(75) Inventors: Jorge D. Acuna, Vail, AZ (US); Deanna Q. Brown, Queen Creek, AZ (US); Elena Schneider, San Francisco, CA (US)

Correspondence Address: Kunzler Needham Massey & Thorpe, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 12/394,345

(22) Filed: Feb. 27, 2009

(51) Int. Cl. H04L 9/32; G06F 21/00

(52) U.S. Cl. 726/19; 713/1

(57) ABSTRACT

An apparatus, system, and method are disclosed for start-up authentication. A prompt module prompts for a hardware password and authentication data on a single display screen. The authentication data comprises a user password. The user password is distinct from the hardware password. A store module stores the authentication data in a target storage space. In addition, the store module stores a pointer to the target storage space in a system register. A retrieve module retrieves the authentication data from the target storage space using the pointer. An authentication module automatically authenticates a user with the authentication data.

### BACKGROUND

1. Field

This invention relates to authentication and more particularly relates to start-up authentication.

2. Description of the Related Art

When a user boots a computer, the user is often prompted for a hardware password before booting of the computer proceeds. In addition, the user is typically later prompted for a password to give access to an operating system. Requiring passwords at multiple times often requires the user to wait at the computer for significant periods of time.

### SUMMARY

The present invention has been developed in response to the present state of the art, and in particular, in response to the problems and needs in the art that have not yet been fully solved by currently available apparatus, systems and methods for start-up authentication. Accordingly, the present invention has been developed to provide an apparatus, system, and method for start-up authentication that overcome many or all of the above-discussed shortcomings in the art.

The apparatus for start-up authentication is provided with a plurality of modules configured to functionally execute the steps of prompting for a hardware password and authentication data, storing the authentication data, storing a pointer, retrieving the authentication data, and authenticating a user. These modules in the described embodiments include a prompt module, a store module, a retrieve module, and an authentication module.

The prompt module prompts for a hardware password and authentication data on a single display screen. The authentication data comprises a user identification and a user password. The user password is distinct from the hardware password.

The store module stores the authentication data in a target storage space. In addition, the store module stores a pointer to the target storage space in a system register. The retrieve module retrieves the authentication data from the target storage space using the pointer. The authentication module automatically authenticates a user with the authentication data.

A system of the present invention is also presented for start-up authentication. In particular, the system, in one embodiment, includes a display, a keyboard, a memory, and a processor module.

The memory stores executable code and data. The processor module processes the executable code and data. The executable code and data comprise a prompt module, a store module, a retrieve module, and an authentication module.

The prompt module prompts for a hardware password and authentication data on a single display screen. The authentication data comprises a user identification and a user password. The user password is distinct from the hardware password.

The store module stores the authentication data in a target storage space. In addition, the store module stores a pointer to the target storage space in a system register. The retrieve module retrieves the authentication data from the target storage space using the pointer. The authentication module automatically authenticates a user with the authentication data.

A method of the present invention is also presented for start-up authentication. The method in the disclosed embodiments substantially includes the steps to carry out the functions presented above with respect to the operation of the described apparatus and system. In one embodiment, the method includes prompting for a hardware password and authenticating data, storing the authentication data, storing a pointer, retrieving the authentication data, and authenticating a user.

A prompt module prompts for a hardware password and authentication data on a single display screen. The authentication data comprises a user password. The user password is distinct from the hardware password.

A store module stores the authentication data in a target storage space. In addition, the store module stores a pointer to the target storage space in a system register. A retrieve module retrieves the authentication data from the target storage space using the pointer. An authentication module automatically authenticates a user with the authentication data.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention automates start-up authentication. Beneficially, such an apparatus, system, and method would automatically authenticate a user by allowing the user to input a hardware password, a user identification, a user password, or the like at one time without any delay. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective drawing illustrating one embodiment of a notebook computer in accordance with the present invention;

FIG. 2 is a schematic block diagram illustrating one embodiment of a computer of the present invention;

FIG. 3 is a schematic block diagram illustrating one embodiment of a memory and system registers of the present invention;

FIG. 4 is a schematic block diagram illustrating one embodiment of authentication data of the present invention;

FIG. 5 is a schematic block diagram illustrating one embodiment of a start-up authentication apparatus of the present invention;

FIG. 6 is a schematic flow chart diagram illustrating one embodiment of a start-up authentication method of the present invention, and

FIG. 7 is a drawing illustrating one embodiment of a start-up display screen of the present invention.

### DETAILED DESCRIPTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform hardwired logic functions, execute computer readable programs stored on tangible storage devices, and/or execute programmed functions. The computer readable programs may in combination with a computer system perform the functions of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

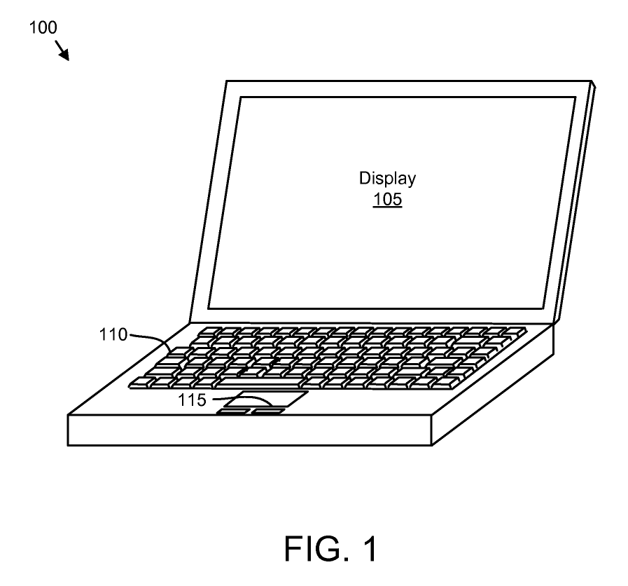

FIG. 1 is a perspective drawing illustrating one embodiment of a notebook computer 100 in accordance with the present invention. The notebook computer 100 includes a display 105, a keyboard 110, and a touchpad 115.

The keyboard 110 may include buttons, keys, or the like in a specified arrangement. For example, the keyboard 110 may be a QWERTY keyboard. Each key or button may have characters engraved or printed on its surface.

A user may press the key or the button to input data, initiate a function, type an alphanumeric character or string, or the like. In addition, the user may press and hold two or more keys simultaneously to produce some special symbols or functions. Additionally, pressing one or more other keys may affect the operation of the notebook computer 100. For example, a user may press a F1 key during starting-up of the notebook computer 100 to automatically enter a Binary Input/Output System (BIOS) configuration or setup screen.

The touchpad 115 may also function as an input device. The touchpad 115 may be selected from a resistive touchpad, a capacitive touchpad, an electromagnetic touchpad, or the like of suitable size to fit in a recess in a body of the notebook computer 100. The user may use a finger, a thumb, or the like to cause spatial movements of a cursor on the display 105. The cursor on the display 105 may move in same direction as a motion of the finger moving on a surface of the touchpad 115. The touchpad 115 may also allow moving the finger along an edge of the touchpad 115 to act as a scroll wheel. The scroll wheel function of the touchpad 115 may allow controlling one or more scrollbars and/or scrolling a window on the display 105.

The display 105 may be configured as a liquid crystal display (LCD), a thin film transistor liquid crystal display (TFT-LCD), or the like. The display 105, keyboard 110, and touchpad 115 may be configured on the notebook computer 100 as is well known to those of skill in the art.

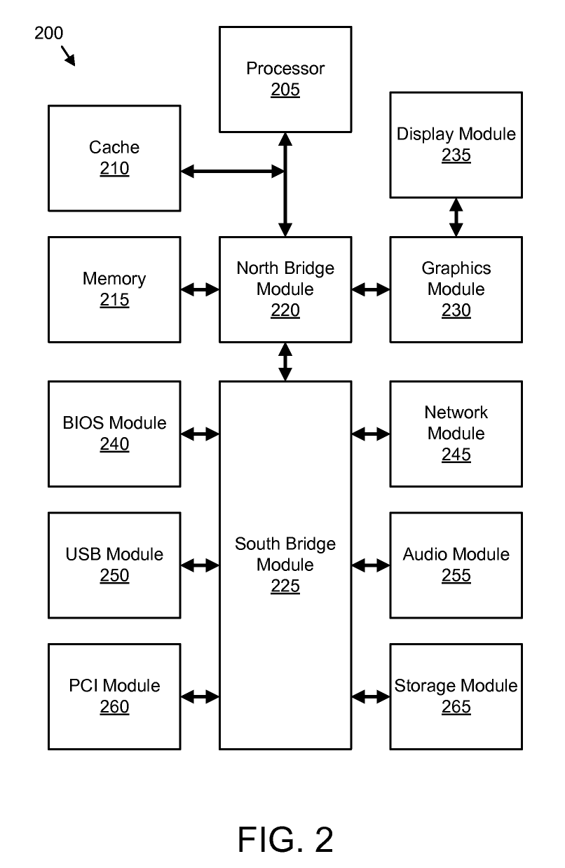

FIG. 2 is a schematic block diagram illustrating one embodiment of a computer 200 in accordance with the present invention. The computer 200 includes a processor 205, a cache 210, a memory 215, a north bridge module 220, a south bridge module 225, a graphics module 230, a display module 235, a BIOS module 240, a network module 245, a Universal Serial Bus (USB) module 250, an audio module 255, a Peripheral Component Interconnect (PCI) module 260, and a storage module 265. The computer 200 may be embodied the notebook computer 100 of FIG. 1.

Although for simplicity, one processor 205, one cache 210, one memory 215, one north bridge module 220, one south bridge module 225, one graphics module 230, one display module 235, one BIOS module 240, one network module 245, one USB module 250, one audio module 255, one PCI module 260, and one storage module 265 are shown with the computer 200, any number of processors 205, caches 210, memories 215, north bridge modules 220, south bridge modules 225, graphics modules 230, display modules 235, BIOS modules 240, network modules 245, USB modules 250, audio modules 255, PCI modules 260, and storage modules 265 may be employed. The description of the computer 200 refers to elements of FIG. 1, like numbers referring to like elements.

The processor 205, cache 210, memory 215, north bridge module 220, south bridge module 225, graphics module 230, display module 235, BIOS module 240, network module 245, USB module 250, audio module 255, PCI module 260, and storage module 265, referred to herein as components. These modules may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory 215 stores executable code and data. The memory 215 may include a volatile memory selected from a Dynamic Random Access Memory (DRAM), a Static Random Access Memory (SRAM), or the like, a non-volatile memory such as read only memory (ROM), a flash memory, or the like.

The processor 205 processes the executable code and data. The processor 205 may communicate over an integrated circuit (IC) processor bus for example, of two gigahertz (2 GHz) to process the executable code and data. The processor 205 may also include sufficient memory to store small quantity of data. The memory of the processor 205 may include a plurality of system registers as is well known to those of skill in the art.

The storage module 265 may include one or more tangible storage devices such as optical storage devices, holographic storage devices, micromechanical storage devices, semiconductor storage devices, hard disk drives, magnetic tapes, or the like. The storage module 265 may communicate with the south bridge module 225 to store or access stored code and data. The code and data may tangibly be stored on the storage module 265. The code and data include a prompt module, a store module, a retrieve module, and an authentication module.

The processor 205 may communicate with the cache 210 through a processor interface bus to reduce average time to access the memory 215. The cache 210 may store copies of the data from the most frequently used storage module locations. The cache 210 may be controlled by a microcontroller in the storage module 265. The microcontroller may be a single IC and may have sufficient memory and interfaces needed for an application. The computer 200 may use one or more caches 210 for example, one or more DDR2 cache memories as is well known to those of skill in the art.

The north bridge module 220 may communicate with and hence may provide a bridging functionality between the processor 205 and the graphics module 230 through a 26-lane PCI express bus, the memory 215, and the cache 210. The north bridge module 220 may be configured as an IC as is well known to those of skill in the art. The processor 205 may be connected to the north bridge module 220 over, for example, a six hundred sixty seven Megahertz (667 MHz) front side bus as is well known to those of skill in the art.

The north bridge module 220 may be connected to the south bridge module 225 through a direct media interface (DMI) bus. The DMI bus may provide a high-speed bi-directional point-to-point link supporting a clock rate for example of the value of two gigabytes per second (2 GBps) in each direction between the north bridge module 220 and the south bridge module 225. The south bridge module 225 may be configured as an IC as is well known to those of skill in the art.

The south bridge module 225 may also include an integrated USB controller. The south bridge module 225 may communicate with the USB module 250 through the USB controller. The USB controller may support a Bluetooth interface, a built-in camera, a built-in track pad, a keyboard 110, an expresscard/34 slot, an external USB port, or the like.

In addition, the south bridge module 225 may communicate with the audio module 255 through an input-output (I/O) device. The audio module 255 may support a built-in microphone, a combination analog audio line-in and Digital Interconnect Format (DIF) digital optical audio line-in jack, a combined analog output and DIF digital optical audio line-out jack, or the like.

The PCI module 260 may communicate with the south bridge module 225 for transferring data or to power peripheral devices. The PCI module 260 may include a PCI bus for attaching the peripheral devices. The PCI bus can logically connect one or more peripheral devices such as printers, scanners, or the like. The PCI module 260 may be configured as a planar device IC and fitted onto a motherboard. The PCI module 260 may also be configured as an expansion card as is well known to those of skill in the art.

The network module 245 may communicate with the south bridge module 225 to allow the computer 200 to communicate with other devices over a network. The devices may include routers, bridges, computers, printers, and the like.

The BIOS module 240 may communicate instructions through the south bridge module 225 to boot the computer 200 or the notebook computer 100, so that software instructions stored on the memory 215 can load, execute, and assume control of the computer 200 or the notebook computer 100. Alternatively, the BIOS module 240 may comprise code and data embedded on a chipset that recognizes and controls various devices that make up the computer 200 or the notebook computer 100.

For example, the BIOS module 240 may carry out a Power On Self Test (POST) that ensures that the computer meets requirements to start-up properly, load a Bootstrap Loader to locate an operating system (OS), load a BIOS program or drivers that interface between the OS and hardware devices, and load a configuration program that may allow to configure hardware settings such as a hardware password, time, date, or the like.

In an embodiment, when the user boots the computer 200 or the notebook computer 100, the user is often prompted for the hardware password before booting of the computer 200 or the notebook computer 100 proceeds. In addition, the user may be typically later prompted for another password to give access to the OS.

The display module 235 may communicate with the graphics module 230 to display elements for example, of a login screen when the user boots the computer 200 or the notebook computer 100. The display module 235 may be the display 105 of FIG. 1. This requiring of passwords at multiple times often requires the user to wait for significant periods of time. The present invention allows the user to enter the hardware password, a user identification, a user password, or the like at one time during the BIOS configuration of the computer 200 or the notebook computer 100 to automate start-up authentication as will be described hereinafter.

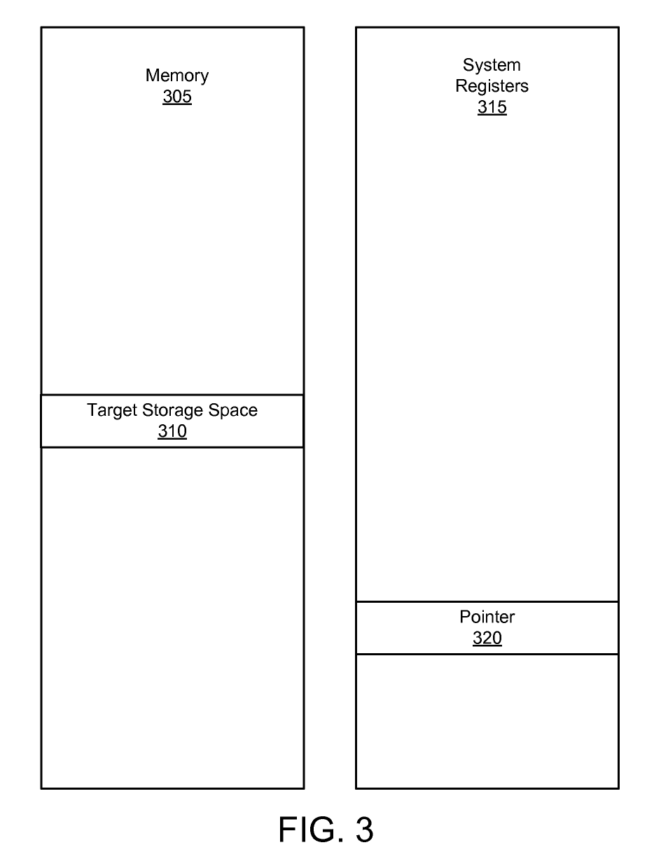

FIG. 3 is a schematic block diagram illustrating one embodiment of a memory 305 and system registers 315 of the present invention. The description of the memory 305 and the system registers 315 refers to elements of FIGS. 1-2, like numbers referring to like elements. The memory 305 may be the memory 215 of FIG. 2.

The memory 305 is shown including a target storage space 310. The target storage space 310 may be at a specified address. The specified address may have a target storage space address. The target storage space address may include a unique identifier for the target storage space 310. The target storage space 310 may store a piece of data for later retrieval stored by computer code and data, one or more hardware devices, or the like.

For example, the target storage space address may be the identifier represented by a binary number from a finite monotonically ordered sequence. In a particular example, the target storage space address may be the identifier represented by a binary number “0x1000001.” In an embodiment, the target storage space address is determined dynamically. For example, the target storage space address configured as the identifier represented by the binary number “0x1000001” may be determined dynamically as is well known to those of skill in the art. Alternatively, the target storage space address may be a specified static address.

The target storage space 310 may also be in volatile memory storage space. For example, the target storage space 310 may be in the random access memory (RAM) storage space as is well known to those of skill in the art. In a particular example, the target storage space 310 may be in the DRAM storage space.

The system registers 315 may include the plurality of registers that configure the memory of the processor 205. For example, the system registers 315 may include one or more data registers, address registers, or the like. Alternatively, the system registers 315 may be located on one or more separate chipsets that may be different from the registers of the memory of the processor 205.

In the shown embodiment, a system register 315 includes the pointer 320. The pointer 320 may be a programming language data type of certain value. For example, the pointer 320 may be an address stored as the data type in a system register 315.

The value of the pointer 320 may refer or point to another value stored at another storage space. Continuing with above example, the pointer 320 configured as the address stored as the data type may refer or point to the target storage space 310 in the RAM or in the target storage space address configured as the identifier represented by the binary number “0x1000001” in the memory 305. The pointer 320 that refers to the target storage space 310 may be configured and stored in a system register 315 by a method well known to those of skill in the art.

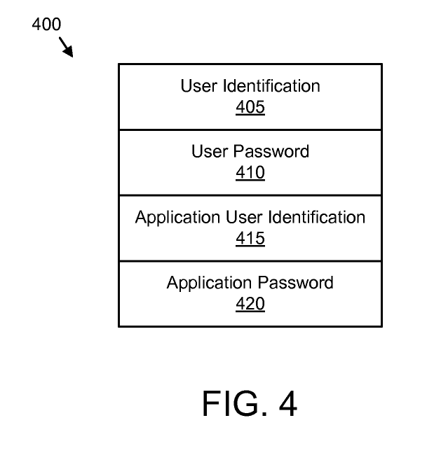

FIG. 4 is a schematic block diagram illustrating one embodiment of authentication data 400 of the present invention. The description of the authentication data 400 refers to elements of FIGS. 1-3, like numbers referring to like elements. The authentication data 400 includes a user identification 405, a user password 410, an application user identification 415, and an application password 420. The authentication data 400 may be stored in the target storage space 310.

The authentication data 400 comprises the user password 410 and the user identification 405. The user password 410 may be a secret password that is shared between the user and the computer 200 or the notebook computer 100. The user password 410 may comprise a personal identification number (PIN), an alphanumeric string, or the like. The user may type the user password 410 using the keyboard 110.

The user password 410 configured as the PIN or the alphanumeric string may include four (4) to ten (10) numerals, alphabets, or a combination thereof. For example, the user password 410 may be configured as the PIN “987489” that includes six (6) numerals. In another example, the user password 410 may be configured as the alphanumeric string “SATaTPP9” that includes one numeral and seven (6) alphabets in capital letters and one alphabet in small letter. The user password 410 may be used to authenticate the user to the computer 200 or the notebook computer 100.

The user identification 405 may comprise a user name, an alphanumeric string, or the like. For example, the user identification 405 may comprise the user name “alexandra.” In another example, the user identification 405 may comprise the alphanumeric string “alexandra78.” The user may type the user identification 405 using the keyboard 110. The user identification 405 may be used to identify the user to notebook computer 100 or the computer 200.

The authentication data 400 may further comprise the application password 420 and the application user identification 415. The application user identification 415 may comprise an application user name, an alphanumeric string, or the like. The application user identification 415 may be distinct from the user identification 405. For example, the user identification 415 may be configured as the alphanumeric string “simon123.” In another example, the user identification 415 may be configured as the application user name “alex.” The application user identification 415 may identify the user to a specific application such as a database, a management console, a network, or the like. The user may type the application user identification 415 using the keyboard 110.

The application password 420 may be a secret password that is shared between the user and the computer 200 or the notebook computer 100. The application password 420 may comprise an alphanumeric string, a number, or the like. The application password 420 may be distinct from the user password 410. For example, the application password 420 may be configured as the number “54321.” In another example, the application password 420 may be configured as the alphanumeric string “aQ46simon.” The user may type the application password 420 using the keyboard 110. The application password 420 may be used to authenticate the user for access to the specific application such as the database, the management console, the network or the like.

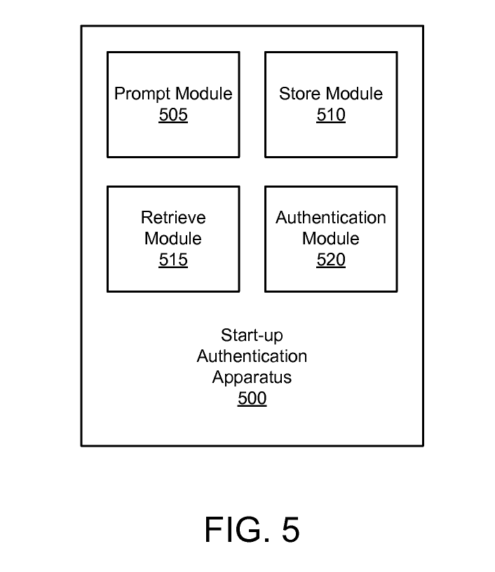

FIG. 5 is a schematic block diagram illustrating one embodiment of a start-up authentication apparatus 500 of the present invention. The apparatus 500 may be embodied in the notebook computer 100 of FIG. 1 or the computer 200 of FIG. 2. The apparatus 500 automates start-up authentication. The description of apparatus 500 refers to elements of FIGS. 1-4, like numbers referring to like elements. The apparatus 500 includes a prompt module 505, a store module 510, a retrieve module 515, and an authentication module 520.

The prompt module 505 prompts for a hardware password and authentication data 400 on a single display screen. The authentication data may be the authentication data 400 of FIG. 4. The single display screen may be the display 105 of FIG. 1.

The hardware password may include a number, an alphanumeric string, or the like. For example, the hardware password may be the number “12345.” In another example, the hardware password may be the alphanumeric string “ASD78tfRTY.” The user may type the hardware password using the keyboard 110. In an embodiment, the hardware password activates the BIOS module 240. In addition, the hardware password may grant access to a hard disk drive storage module 265.

The authentication data 400 comprises the user password 410 and the user identification 405. The user password 410 is distinct from the hardware password. For example, the hardware password configured as the number “12345” may be distinct from the user password 410 configured as the alphanumeric string “SATaTPP9.” In addition, the authentication data 400 may comprise the application password 420 and the application user identification 415.

The prompt module 505 may include a computer readable program stored on a tangible storage device. The computer readable program is executed on the computer 200 or the notebook computer 100. In one embodiment, the computer readable program is stored on a memory 215 such as ROM, Flash RAM, hard disk drive, or the like and is executed by the processor 205 of the computer 200 or the notebook computer 100.

The store module 510 stores the authentication data 400 in the target storage space 310. For example, the store module 510 may store the authentication data 400 that may comprise the user identification 405 configured as the user name “alexandra,” the user password 410 configured as the PIN “987489,” the user identification 415 configured as the user name “alex,” and the application password 420 configured as the alphanumeric string “aQ46simon” in the target storage space 310 that may have the target storage space address configured as the identifier represented by the binary number “0x1000001.”

In addition, the store module 510 stores the pointer 320 to the target storage space 310 in the system register 315. The pointer 320 may be the pointer 320 of FIG. 3. For example, the store module 510 may store the pointer 320 to the target storage space 310 in the system register 315 as is well known to those of skill in the art.

The store module 510 may include a computer readable program stored on a tangible storage device. The computer readable program is executed on the computer 200 or the notebook computer 100. In one embodiment, the computer readable program is stored on a memory 215 such as ROM, Flash RAM, hard disk drive, or the like and is executed by the processor 205 of the computer 200 or the notebook computer 100.

The retrieve module 515 retrieves the authentication data 400 from the target storage space 310 using the pointer 320. The retrieve module 515 may include a computer readable program stored on a tangible storage device. The computer readable program is executed on the computer 200 or the notebook computer 100. In one embodiment, the computer readable program is stored on a memory 215 such as ROM, Flash RAM, hard disk drive, or the like and is executed by the processor 205 of the computer 200 or the notebook computer 100.

The authentication module 520 automatically authenticates the user with the authentication data 400. In an embodiment, the authentication module 520 authenticates the user to the OS using the user password 410 and the user identification 405. In addition, authentication module 520 may authenticate the user to the specified application using the application password 420 and the application user identification 415.

The authentication module 520 may include a computer readable program stored on a tangible storage device. The computer readable program is executed on the computer 200 or the notebook computer 100. In one embodiment, the computer readable program is stored on a memory 215 such as ROM, Flash RAM, hard disk drive, or the like and is executed by the processor 205 of the computer 200 or the notebook computer 100.

The schematic flow chart diagram that follows is generally set forth as logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

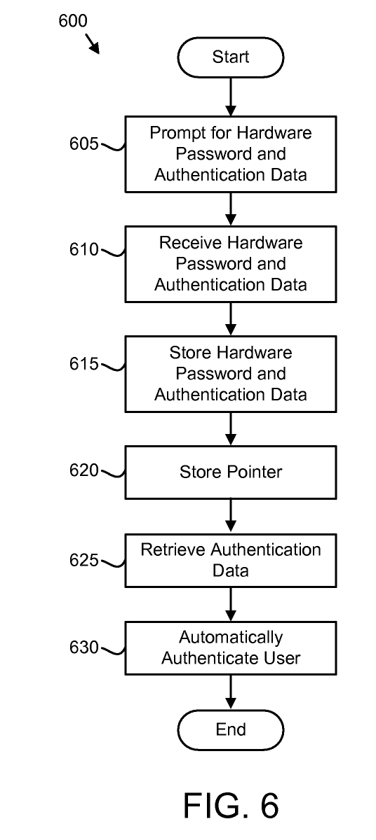

FIG. 6 is a schematic flow chart diagram illustrating one embodiment of a start-up authentication method 600 of the present invention. The method 600 substantially includes the steps to carry out the functions presented above with respect to the operation of the described apparatus 500, notebook computer 100, and computer 200. The description of the method 600 refers to elements of FIGS. 1-5, like numbers referring to the like elements.

The method 400 begins, and in one embodiment, the prompt module 505 prompts 605 for the hardware password and the authentication data 400 on the single display screen. The authentication data 400 may be the authentication data 400 of FIG. 4.

For example, the prompt module 505 may automatically display a first field, a second field, a third field, and the like on the display 105. Each field may allow the user to input data. In addition, the prompt module 505 may display a blinker, an indicator, or the like in each field one-by-one. Continuing with the above example, the prompt module 505 may prompt 605 for the hardware password in the first field, for the user identification 405 in the second field, and for the user password in the third field, or the like.

In addition, the prompt module 505 may receive 610 the hardware password and the authentication data 400. For example, when the user completes inputting the hardware password and the authentication data 400 using the keyboard 110 and presses an “enter” key on the keyboard 110, the prompt module 505 may automatically receive 610 the hardware password and the authentication data 400. Alternatively, when the user completes inputting the hardware password and the authentication data 400 in each field one-by-one, the prompt module 505 may automatically receive 610 the hardware password and the authentication data 400

The hardware password may activate the BIOS module 240. For example, when the processor 205 exactly matches the inputted hardware password configured as the number “12345” with the stored hardware password configured as the number “12345,” the hardware password may automatically activate the BIOS module 240. Alternatively, the hardware password may grant access to a hard disk drive storage module 265.

The store module 510 stores 615 the authentication data 400 in the target storage space 310. For example, the store module 510 may automatically store 615 the authentication data 400 comprising the user identification 405 configured as the user name “Alexandra” and the user password 410 configured as the alphanumeric string “SATaTPP9” in the RAM, when the user firstly types and enters the authentication data 400.

In another example, the store module 510 may automatically store 615 the authentication data 400 comprising the user identification 405 configured as the alphanumeric string “Alexandra78” and the user password 410 configured as the PIN “987489” at the target storage space address configured as the identifier represented by the binary number “0x1000001” in the memory 215, when the user firstly types and enters the authentication data 400.

In addition, the store module 510 stores 620 the pointer 320 to the target storage space 310 in the system register 315. In one embodiment, the pointer 320 is stored 620 in a predetermined register and/or a register address. The pointer 320 to the target storage space 310 and the system register 315 may be the pointer 320 and the system register 315 of FIG. 3 respectively.

The store module 510 may also store 615 the hardware password. For example, when the user firstly types and enters the hardware password configured as the number “12345”, the store module 510 may automatically store 615 the hardware password in the memory of the processor 205 as is well known to those of skill in the art.

The retrieve module 515 retrieves 625 the authentication data 400 from the target storage space 310 using the pointer 320. For example, the retrieve module 515 may automatically access the pointer 320 to look for the target storage space 310 and automatically retrieve 625 the authentication data 400 from the target storage space 310 in response to an OS login screen. In a particular example, the retrieve module 515 may automatically access the pointer 320 that may refer or point to the target storage space 310 having the target storage space address represented by the binary number “0x1000001” and automatically retrieve 625 the authentication data 400 comprising the user identification 405 configured as the alphanumeric string “Alexandra78” and the user password 410 configured as the PIN “987489.”

The authentication module 520 automatically authenticates 630 the user with the authentication data 400 and the method 600 terminates. The authentication module 520 may provide the authentication data 400 to the OS login screen, an application login screen, or the like to authenticate 630 the user. Thus, the method 600 automates start-up authentication by allowing the user to input the hardware password, the user identification 405, the user password 410, or the like at one time without any delay. A user may enter a series of identifiers and passwords, leave for an extended period, and return to have all authentications complete.

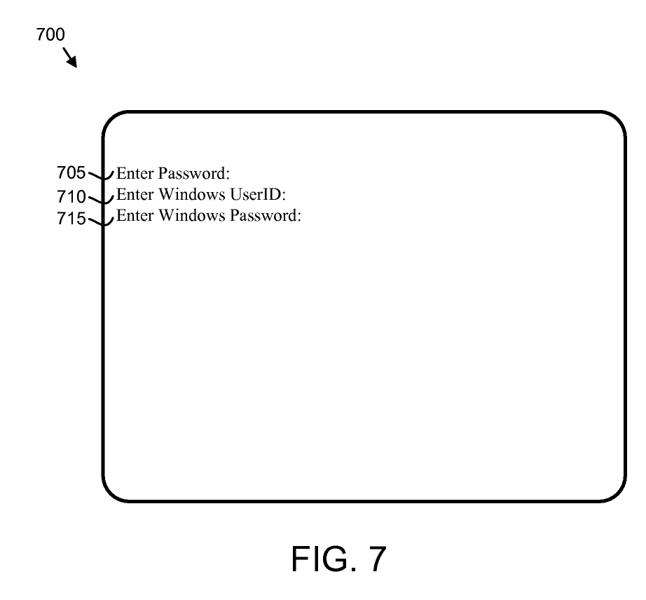

FIG. 7 is a drawing illustrating one embodiment of a start-up display screen 700 of the present invention. The description of display screen 700 refers to elements of FIGS. 1-6, like numbers referring to the like elements.

In the shown embodiment, the display screen 700 includes a first field 705, a second field 710 and a third field 715. Further, the first field 705 is shown with a tag “Enter password,” the second field 710 is shown with a tag “Enter Windows UserID,” and the third field 715 is shown with a tag “Enter Windows Password.”

The prompt module 505 may prompt 605 for the hardware password and authentication data 400 on the single display screen by displaying the first field 705 with the tag “Enter password,” the second field 710 with the tag “Enter Windows UserID,” and the third field 715 with the tag “Enter Windows Password.” The user may type the hardware password in the first field 705, the user identification 405 in the second field 710, and the user password 410 in the third field 715. The present invention allows the user to input the hardware password, the user identification 405, the user password 410, or the like at one time in the displayed screen 700.

The present invention automates start-up authentication. Beneficially, such an apparatus, system, and method would automatically authenticate the user by allowing the user to input the hardware password, the user identification 405, the user password 410, or the like at one time without any delay. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer program product comprising a computer readable program stored on a tangible storage device, wherein the computer readable program when executed on a computer causes the computer to:
prompt for a hardware password and authentication data on a single display screen, the authentication data comprising a user password distinct from the hardware password;
store the authentication data in a target storage space;
store a pointer to the target storage space in a system register;
retrieve the authentication data from the target storage space using the pointer; and
automatically authenticate a user with the authentication data.

2. The computer program product of claim 1, wherein the hardware password grants access to a hard disk drive.

3. The computer program product of claim 1, wherein the hardware password activates a Binary Input/Output System (BIOS) module.

4. The computer program product of claim 1, wherein the target storage space is at a specified address.

5. The computer program product of claim 1, wherein a target storage space address is determined dynamically.

6. The computer program product of claim 1, wherein the authentication data further comprises a user identification.

7. The computer program product of claim 6, wherein the computer readable program is further configured to cause the computer to automatically grant access to an operating system using the user password and the user identification.

8. The computer program product of claim 1, wherein the authentication data further comprises an application password and an application user identification.

9. The computer program product of claim 8, wherein the computer readable program is further configured to cause the computer to automatically grant access to a specified application using the application password and the application user identification.

10. The computer program product of claim 1, where the target storage space is in volatile memory storage space.

11. An apparatus for start-up authentication, the apparatus comprising:
a prompt module that prompts for a hardware password and authentication data on a single display screen, the authentication data comprising a user identification and a user password distinct from the hardware password;
a store module that stores the authentication data in a target storage space and stores a pointer to the target storage space in a system register;
a retrieve module that retrieves the authentication data from the target storage space using the pointer; and
an authentication module that automatically authenticates a user with the authentication data.

12. The apparatus of claim 11, wherein the authentication module further authenticates the user to an operating system using the user password and the user identification.

13. The apparatus of claim 11, wherein the authentication data further comprises an application password and an application user identification.

14. The apparatus of claim 13, wherein the authentication module further authenticates the user to a specified application using the application password and the application user identification.

15. The apparatus of claim 11, where the target storage space is in volatile memory storage space.

16. A system for start-up authentication, the system comprising:
a display;
a keyboard;
a memory storing executable code and data;
a processor module that processes the executable code and data, the executable code and data comprising
a prompt module that prompts for a hardware password and authentication data on a single display screen, the authentication data comprising a user identification and a user password distinct from the hardware password;
a store module that stores the authentication data in a target storage space and stores a pointer to the target storage space in a system register;
a retrieve module that retrieves the authentication data from the target storage space using the pointer; and
an authentication module that automatically authenticates a user with the authentication data.

17. The system of claim 16, further comprising a hard disk drive wherein the hardware password grants access to the hard disk drive.

18. The system of claim 16, further comprising a BIOS module and wherein the hardware password activates the BIOS module.

19. The system of claim 16, wherein the target storage space is at a specified static address.

20. A method for deploying computer infrastructure, comprising integrating a computer readable program stored on a tangible storage device into a computing system, wherein the program in combination with the computing system is capable of performing the following:
prompting for a hardware password and authentication data on a single display screen, the authentication data comprising a user identification and a user identification and a user password distinct from the hardware password;
storing the authentication data in a target storage space;
storing a pointer to the target storage space in a system register;
retrieving the authentication data from the target storage space using the pointer;
automatically authenticating a user with the authentication data to an operating system.
